(19) United States
(12) Patent Application Publication
(10) Pub. No.: US 2013/0229274 A1
(43) Pub. Date: Sep. 5, 2013

(54) THEFT DETECTION SYSTEMS AND METHODS

(71) Applicants: UNIVERSITY OF MEMPHIS RESEARCH FOUNDATION, Memphis, TN (US); THE OHIO STATE UNIVERSITY, Columbus, OH (US); THE REGENTS OF THE UNIVERSITY OF CALIFORNIA, Oakland, CA (US)

(72) Inventors: Santosh Kumar, Germantown, TN (US); Prasun Sinha, Columbus, OH (US); Kurt Plarre, Germantown, TN (US); Somnath Mitra, Memphis, TN (US); Zizhan Zheng, Columbus, OH (US); Santanu Guha, Memphis, TN (US); Animikh Ghosh, Memphis, TN (US); Prabal Dutta, Oakland, CA (US); Bhagavathy Krishna, Memphis, TN (US)

(73) Assignees: University of Memphis Research Foundation, Memphis, TN (US); The Regents of the University of California, Oakland, CA (US); The Ohio State University, Columbus, OH (US)

(21) Appl. No.: 13/775,803

(22) Filed: Feb. 25, 2013

Related U.S. Application Data
(63) Continuation of application No. 13/386,311, now abandoned.
(60) Provisional application No. 61/226,865, filed on Jul. 20, 2009.

(51) Int. Cl. B60R 25/102

(52) U.S. Cl. CPC B60R 25/102
USPC 340/429; 340/572.1

(57) ABSTRACT

One aspect of the invention provides a theft detection system including one or more tag nodes configured to detect movement and transmit a beacon message and one or more anchor nodes configured to receive the beacon message from the one or more tag nodes and alert a third party of the beacon message. Another aspect of the invention provides a theft detection node including a power source, a motion detector, a transmitter, and a microcontroller in communication with the power source, the motion detector, and the transmitter. The microcontroller is configured to determine whether the node is being transported and if the node is being transported, instructing the transmitter to transmit a beacon message. Another aspect of the invention provides a theft detection method including detecting motion in a motor vehicle and transmitting a beacon message to an anchor node.

### CROSS-REFERENCE TO RELATED APPLICATIONS

This application is a continuation of U.S. application Ser. No. 13/386,311, filed Jan. 20, 2012, which is a 35 U.S.C. §371 U.S. national entry of International Application PCT/US2010/042590 (WO 2011/011405) having an International filing date of Jul. 20, 2010 which claims priority to U.S. Provisional Patent Application Ser. No. 61/226,865, filed Jul. 20, 2009. The entire contents of these applications are hereby incorporated by reference herein.

### BACKGROUND

Burglary is a traumatic event that continues to pervade society. Burglar alarms, closed circuit surveillance, and the like deter criminals but rarely lead to the arrest of suspects. Investigating burglary post facto is expensive, difficult, and a relatively lower priority to police.

According to the FBI Uniform Crime Reporting Program, burglary offenses accounted for 22.1% of all estimated property crimes and resulted in $4.3 billion in losses in 2007. Loss of property aside, a burglary incident is a traumatic experience for its victims.

Due to the difficulty and expense of investigation, burglaries often do not receive the same priority from resource-strapped law enforcement agencies as other crimes such as homicide. Consequently, burglary continues to pervade even the most prosperous nations and may become more prevalent in the current economic recession, despite a plethora of anti-burglary devices that have been commercially available for more than a decade.

Most existing anti-burglary systems such as security cameras, alarm systems, motion sensor based alarm systems, and the like only deter burglars, leaving burglars to seek more vulnerable properties in the neighborhood. In the event of a bold burglar stealing an alarmed item, alarms are useful only if they help to catch the burglar at the scene of crime. Once the burglar flees the scene of crime, recovering the stolen item is extremely difficult. Resource-strapped law enforcement agencies are understandably reluctant to undertake these expensive investigations when more serious crimes are competing for their attention.

Law enforcement agencies would very much like to address burglaries because one burglary in a neighborhood makes citizens in the entire neighborhood feel vulnerable. However, currently available asset tracking devices suffer from several deficiencies.

For example, many tracking devices (e.g., systems available under the LOJACK® trademark from LoJack Corporation of Westwood, Mass.) utilize the Global Positioning System (GPS) and/or cellular infrastructure to obtain location information and cellular infrastructure to transmit location information. The lifespan of such devices without charging ranges between about three days to one week. Additionally, these devices incur recurring expenses for the use the cellular infrastructure and introduce a requirement for complete cellular network coverage.

Other systems employ the frequent exchange of messages among neighboring sensors hidden in parked cars to detect in any neighboring vehicles are missing from a parking lot. However, such an approach quick drains the battery of the sensor.

Accordingly, there is a need for an affordable, easy-to-use, low-power theft detection system.

### SUMMARY OF THE INVENTION

One aspect of the invention provides a theft detection system including one or more tag nodes configured to detect movement and transmit a beacon message and one or more anchor nodes configured to receive the beacon message from the one or more tag nodes and alert a third party of the beacon message.

In one embodiment, the one or more tag nodes include a power source, a motion detector, a transmitter, an accelerometer, and a microcontroller. The power source can be a battery. The motion detector can be a vibration dosimeter. The motion detector can be a piezoelectric vibratab. The transmitter can be a transceiver. The transmitter can be IEEE 802.15.4-compliant. The microcontroller can be configured to receive a wake-up signal from the motion detector.

The one or more anchor nodes can include a power source, an infrastructure interface, an intra-anchor node interface, a mote, and a motherboard. The power source can include one or more cells. The infrastructure interface can be an IEEE 802.11-compliant transceiver. The intra-anchor node interface can be an IEEE 802.15.4-compliant transceiver.

The tag node can be configured for arming and disarming through a series of accelerations. The tag node can be embedded in an electronic device. The tag node can be configured to arm and disarm another tag node. The tag node can be configured to detect movement in a motor vehicle. The tag node can be configured to detect movement in a motor vehicle with a classification algorithm.

The one or more anchor nodes can be deployed to provide section coverage with diameter x with a region, wherein x is a positive number. The region can be one selected from the group consisting of: a precinct, a ward, a municipality, a county, a state, and a country. A subset of the one or more anchor nodes can be mounted within law enforcement vehicles.

The one or more anchor nodes can be configured to transmit an acknowledgment message to a subset of the one or more tag nodes. The acknowledgment message can include an estimated travel time to a nearest anchor node. The acknowledgement message can include instructions to enter a sleep state. The acknowledgement message can include instructions to not enter a sleep state. The acknowledgement message can include one or more group IDs pertaining to one or more subsets of the tag nodes.

The third party can be a computer. The third party can be a law enforcement agency.

Another aspect of the invention provides a theft detection node including a power source, a motion detector, a transmitter, and a microcontroller in communication with the power source, the motion detector, and the transmitter. The microcontroller is configured to determine whether the node is being transported and if the node is being transported, instructing the transmitter to transmit a beacon message.

The power source can be a battery. The battery can be a button cell or a lithium battery. The motion detector is a vibration dosimeter or a piezoelectric vibratab. The transmitter can be a radio transmitter. The transmitter can be a transceiver. The transmitter can be IEEE 802.15.4-compliant.

The microcontroller can be configured to receive a wake-up signal from the motion detector. The microcontroller can be configured to determine whether the theft detection node is being transported in motor vehicle. The microcontroller can determine whether the node is being transported by a motor vehicle with a classification algorithm.

Another aspect of the invention provides a theft detection method including detecting motion in a motor vehicle and transmitting a beacon message to an anchor node.

In one embodiment, the method includes receiving a wake-up signal from a motion detector. In another embodiment, the method includes receiving an acknowledgement message from the anchor node. The method can include entering a sleep mode. The method can also include transmitting a second beacon message.

Another aspect of the invention provides a theft detection method including receiving a beacon message from a tag node, transmitting an acknowledgement message to the tag node, and alerting a third party of the beacon message.

In one embodiments, the acknowledgment message includes a travel time to a nearest anchor node.

### FIGURES

For a fuller understanding of the nature and desired objects of the present invention, reference is made to the following detailed description taken in conjunction with the figure wherein:

FIG. 1 depicts a theft detection system in accordance with one embodiment of the invention.

FIGS. 2A and 2B depict tag nodes in accordance with various embodiments of the invention.

FIG. 3A depicts a vibration dosimeter according to one embodiment of the invention.

FIG. 3B depicts the operation vibration dosimeter according to one embodiment of the invention.

FIG. 4 depicts an anchor node according to one embodiment of the invention.

FIG. 5 is a state transition diagram depicting the operation of a tag node according to one embodiment of the invention.

FIG. 6 depicts a dial according to one embodiment of the invention.

FIG. 7 depicts the percentage of misinterpreted passwords for dials having various numbers of characters.

FIG. 8 depicts the average number of seconds required to enter a password correctly for passwords having various numbers of characters.

FIG. 9 depicts the average number of attempts required to enter a password correctly for passwords having various numbers of characters.

FIG. 10A depicts the acceleration signal generated by a tag node according to one embodiment of the invention.

FIG. 10B depicts the interquartile range of a signal obtained from acceleration measurements from a tag node according to one embodiment of the invention.

FIG. 10C depicts the variance of a signal obtained from acceleration measurements from a tag node according to one embodiment of the invention.

FIG. 11 depicts the modeling of a road network R as a connected undirected geometric graph G=(V, E) according to one embodiment of the invention.

FIG. 12 depicts a two-stage algorithm for calculating Section Coverage according to one embodiment of the invention.

FIG. 13 depicts the percentage of tag nodes that may miss detection by an anchor node and the percentage of tag nodes that may miss a sleep acknowledgement from an anchor node if the tag nodes are traveling together and are to be acknowledged individually.

FIGS. 14A and 14B depict the effect of including multiple groups in a sleep acknowledgement on mitigating congestion as the number of nodes traveling together is varied between 5 and 50. Nodes are organized in groups of five or six with a single node in a separate group of its own. The number of groups that are acknowledged together in a single sleep acknowledgement is varied between 1, 2, and 6. FIG. 14A depicts the percentage of nodes that miss a sleep acknowledgement. FIG. 14B depicts the average number of groups that are not detected by the anchor node.

FIG. 15 depicts the Connected Distance Sampling (CDS) algorithm.

FIGS. 16A and 16B depict two road networks spanning 10 km² areas of different densities.

FIGS. 17A and 17B are box plots depicting the percentage of x-pairs not covered by the CDS algorithm in the sparse network and dense network, respectively.

FIG. 18A depicts the average number of anchor nodes for the Section Coverage algorithm under various x-values in systems having ten gateways.

FIG. 18B depicts the average number of hops from each anchor node to the closest network infrastructure gateway for the Section Coverage algorithm.

FIG. 19 depicts the average round trip time to receive an acknowledgement from an anchor node in response to a beacon message from a tag node at a major street intersection.

FIG. 20 depicts the results from driving on a 9.5 mile loop 10 times over 5 hours. For each segment of the loop, the first bar depicts the travel time estimate from GOOGLE® Maps, the second bar depicts the average time that tag nodes slept in that segment. The last three bars denote the maximum, average, and minimum actual times, respectively, take in traveling in each segment.

### DESCRIPTION OF THE INVENTION

Embodiments of the invention provide theft detection systems and methods.

Ideally, a theft detection system should be affordable, have minimal compliance requirements from the owner (e.g., no need for battery recharging, reporting, and the like) and have a very low false alarm rate. In addition, detection of burglary incidents should be autonomous and timely so that burglars can be caught with the evidence of crime, making arrest, investigation, prosecution, and recovery of stolen items simpler and less expensive. Finally, in order to lead to the arrest of burglars (rather than deter them), the burglars should not be able to determine whether an asset is tagged. Otherwise, burglars may steal only unprotected assets to evade capture.

### System Architecture

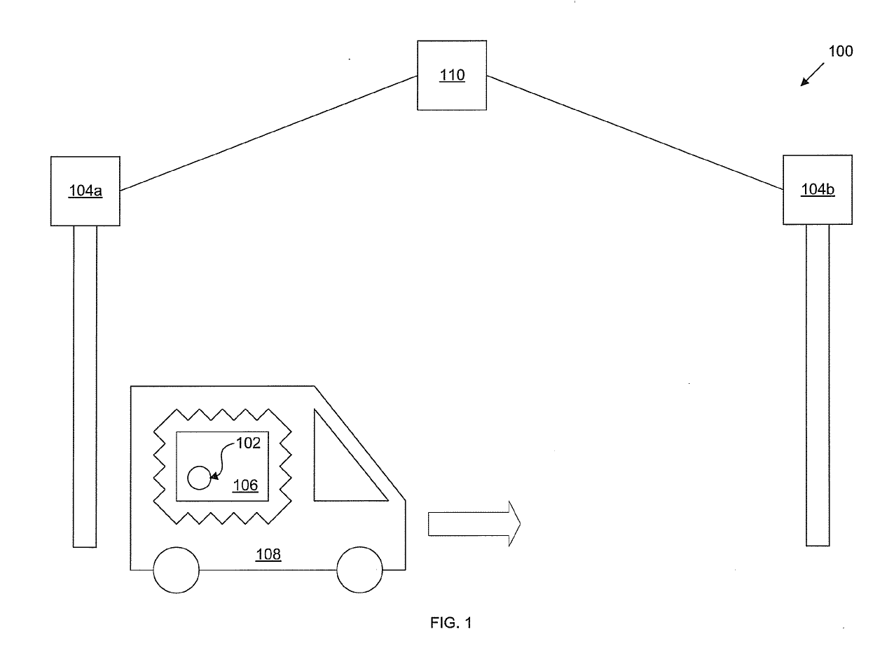

Referring to FIG. 1, one embodiment of the invention provides a theft detection system 100 including (i) a tag node 102 that is attached and/or placed within assets 106 for automatic theft detection at a low cost and on ultra-low energy and (ii) a low-cost and scalable citywide infrastructure of anchor nodes 104a, 104b to track the movement of stolen assets 106 in real-time. Embodiments of the invention autonomously detect the theft of assets 106 without requiring reporting from its owner. Embodiments of the invention then provide real-time updates on the current location of fleeing suspects to law enforcement personnel. Embodiments of the invention emphasize low cost, energy-efficiency, and compliance-free usage.

One embodiment of the invention includes a battery-powered tag node 102 for attachment to assets 106 that are likely to be stolen and a city-wide set of anchor nodes 104 that enable energy-efficient tracking in real-time. The tag nodes 102 are to be hidden in assets 106 such as televisions, audio equipment, antiques, pianos, desktop computers, washers, dryers, HVAC units, and the like that are not moved frequently in vehicles 108. Since burglary usually occurs in the absence of the owners, these assets 106 are more likely to be left in a dwelling and taken by a burglar.

Embodiments of the tag node 102 consume extremely low amounts of power so that the tag node 102 can last about ten years on a standard coin cell battery. Embodiments of the tag nodes 102 are also ultra low cost so each user may purchase dozens of tag nodes 102. Embodiments of the tag nodes 102 also have a small footprint so that they can be hidden easily in a wide variety of assets 106.

Embodiments of the tag node 102 detect theft autonomously using a hierarchical wake-up system of passive and active vibration sensors. The transceiver of the tag node 102 is turned off unless a theft event has indeed occurred, and the stolen asset 106 is being driven on the street, to keep theft detection stealthy and energy-efficient. The vibration sensor on the tag node 102 can also be leveraged for several other tasks including in a novel procedure for arming/disarming of the tag node 102.

In one embodiment, anchor nodes 104 are deployed on roadways to enable low cost and energy-efficient tracking of the stolen asset 106 in real-time. This deployment can be based on a novel coverage model described herein called “Section Coverage.” A network of anchor nodes 104 providing Section Coverage of a given diameter x partitions the road network into sections each of which has a diameter of at most x. The Section Coverage scheme, therefore, ensures that no tag node 102 can move an absolute displacement of x without coming in contact with an anchor node 104. Consequently, at any given moment, the location of a stolen tag node 102 can be pinpointed to a particular section. Contrary to full coverage schemes (the model for cellular and wireless mesh networks) that demand that all points in the region to be covered, the configurable parameter x in the Section Coverage scheme allows for a sparse deployment, depending on the availability of funds/resources, while still providing a guarantee on the quality of tracking. The Section Coverage scheme exploits the fact that stolen items are usually taken on the road in vehicles 108 to reduce the cost of anchor node deployment by an order of magnitude.

In some embodiments, anchor nodes 104 are in communication with a control device 110. The control device can be monitored by a law enforcement agency or a third party (e.g., a private security company) for the monitoring of beacon messages received by anchor nodes 104 from tag nodes and coordinating an appropriate response.

### Tag Nodes

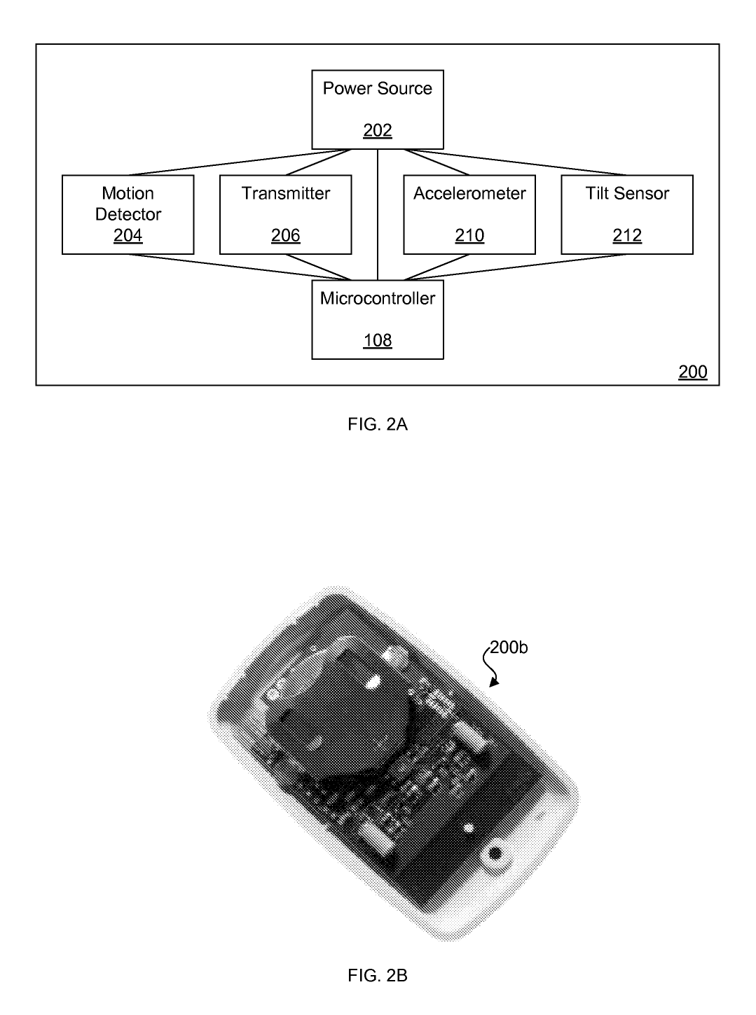

Referring now to FIG. 2A, an embodiment of a tag node 200a is depicted. The tag node 200a includes a power source 202, a motion detector 204, a transmitter 206, and a microcontroller 208. The motion detector 204, transmitter 206, and microcontroller 208 are each coupled to the power source 202. The motion detector 204 and transmitter 206 are also coupled to the microcontroller 208.

The internal structure of an assembled tag node 200b according to one embodiment of the invention is depicted in FIG. 2B. Embodiments of the assembled tag node 200b have dimensions on the order of about 51 mm×34 mm×10 mm.

### Power Source

Power source 202 is preferably a battery in order to eliminate the need to connect the tag node 200 with an external power source, thereby allowing the tag node 200 to be less obtrusive, and permitting the tag node 200 to function once the stolen asset 106 in which the tag node 200 is hidden is removed from owner's dwelling. A variety of batteries can be used as will be appreciated by those of skill in art. The key battery selection criteria are self-discharge rate (which affects shelf-life), energy density (which affects size), and cost (which affects viability). The common lithium manganese dioxide (LiMnO2) primary cell provides a good mix of features well-suited to this application. Such batteries exhibit a shelf-life of over 10 years at room temperature and are often used as a permanent component for the entire lifetime of electronic systems. Their bulk volumetric energy density is approximately 600 mWh/cm³, although for some small batteries like photo/coin cells, the effective volumetric energy density can be lower due to packaging overhead. Commonly-available lithium coin cells in the CR family, like the ENERGIZER® CR2032 battery, available from Eveready Battery Company, Inc. of St. Louis, Mo., are widely-used in consumer products, making them relatively inexpensive. Although alkaline primary cells also have low self-discharge rates, their volumetric energy density is half of the lithium primary cells, which increases size, and their terminal voltage drop makes voltage regulation more important.

The ENERGIZER® CR2032 battery has a 10+ year shelf-life (losing only 15-20% of its capacity at room temperature), provides an energy density of 653 mWh/cm³ (supplying over 200 mAh in a 1 cm³ package), and is available for less than $1 through retail channels (and substantially less in bulk). These figures translate to an approximately 2.5 μA-decade/cm³ charge density, which suggests that the average current draw should be less than 2 μA to achieve a 10-year lifetime.

### Motion Detection

Motion detector 204 can be any device capable of distinguishing between an object at rest from an object in (prolonged) motion. Preferably, motion detector 204 draws less than 2 μA current

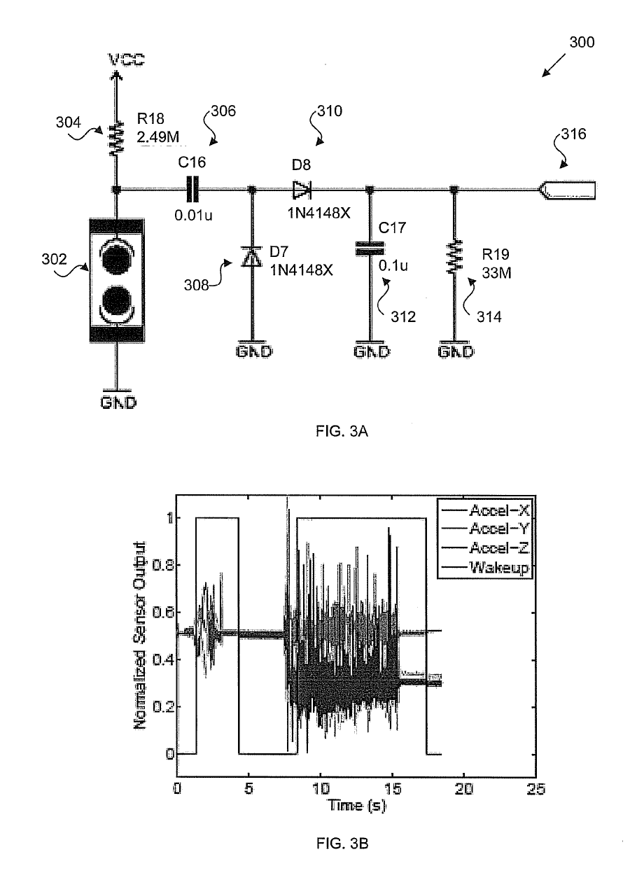

In one embodiment, motion detector 204 is a vibration dosimeter such as the vibration dosimeter 300 shown in FIG. 3A. The vibration dosimeter 300 includes an omnidirectional vibration switch 302 that is nominally closed at rest but chatters open and closed in response to movement. Suitable switches 302 include those in the SQ-SEN-200 series available from SignalQuest, Inc. of Lebanon, N.H. Switch 302 is connected to ground on one terminal and in series with a pull-up resistor 304 to power on the other terminal. The 2.49 MW pull-up resistor 304 sets the quiescent current draw of the circuit. At rest, the circuit draws 1.2 μA at 3 V. A capacitor 306 AC-couples the output of the switch 302, a first diode 308 steers negative voltage transients to ground, and a second diode 310 steers positive transients to a capacitor 312 that integrates these signals. A resistor 314 in parallel with the integration capacitor 312 slowly discharges the capacitor 312 so that in the absence of motion, the capacitor voltage goes to zero.

FIG. 3B shows the vibration dosimeter 300 in operation. Tri-axial acceleration samples taken at 200 Hz are shown with their bias removed and amplitude scaled. The output of the motion detection wake-up circuit 300 can be seen as a pulse that alternates between zero and one as the sensor transitions from rest to motion. At time t=0.5 s, a tag node 200 is picked up and moved and at time t=1.33 s, the motion detector circuit wake-up triggers, waking up the sleeping microcontroller 208 using interrupt line 316. At time t=3.09 s, the tag node 200 stops moving and time t=4.3 s, the motion detector output indicates movement has stopped. This process repeats for a second, longer, and more significant motion starting at time t=7.5 s.

In another embodiment, motion detector 204 is a piezo-electric vibratab that generates electricity to trigger an interrupt when vibrated. Suitable vibratabs include the MiniSense 100 vibration sensor available from Measurement Specialties, Inc. of Hampton, Va. and are described in publications such as Mateusz Malinowski, “CargoNet: Micropower Sensate Tags for Supply-Chain Management and Security” (February 2000) (Master's Thesis) (Mass. Inst. of Tech. Elec. Eng. & Comp. Sci. Dep't); and Mateusz Malinowski et al., “CargoNet: A Low-Cost MicroPower Sensor Node Exploiting Quasi-Passive Wake-up for Adaptive Asynchronous Monitoring of Exceptional Events,” in “Proc. 5th Int'l Conf. on Embedded Networked Sensor Systems” 145-60 (November 2007).

### Transmitter

Transmitter 206 is preferably a radio transmitter. In some embodiments, transmitter 206 is only capable of sending data. In other embodiments, transmitter 206 is a transceiver capable of both sending and receiving data.

In some embodiments, transmitter 206 is a low-power transmitter in accordance with the IEEE 802.15.4 standard. Such devices include the CC2420 2.4 GHz transceiver available from the Chipcon Products unit of Texas Instruments of Dallas, Tex.

### Microcontroller

Microcontroller 208 receives inputs from motion detector 204 and transmitter 206 and controls the operation of transmitter 206. Microcontroller 208 can be selected from a variety of commercially available devices including: the Atmega 128L, ATmega 1281, and ATmega 2561 models available from Atmel Corporation of San Jose, Calif.; the EM250 model available from Ember Corporation of Boston, Mass.; the HC05, HC08, HCS08, and MC13213 models available from Freescale Semiconductor, Inc. of Austin, Tex.; the JN5121 and JN5139 models available from Jennic Ltd of Sheffield, United Kingdom; the MSP430F149, MSP430F1611, MSP430F2618, MSP430F5437, and CC2430 models available from Texas Instruments of Dallas, Tex.; and the eZ80F91 model available from ZiLog, Inc. of San Jose, Calif. In some embodiments, the tag node 200 utilizes the “Epic Core” architecture (including the TEXAS INSTRUMENTS® MSP430F1611 microcontroller) described in Prabal Dutta et al., “A Building Block Approach to Sensornet Systems,” in “SenSys '08: Proc. 6th ACM Conf. on Embedded Network Sensor Systems” 267-80 (2008).

Microcontroller 208 is programmed to receive a wake-up signal from the motion detector 204, determine whether the tag node 200 is being transported by a motor vehicle, and if the tag node 200 is being transported by a motor vehicle 108, instructing the transmitter 206 to transmit a beacon signal.

### Accelerometer

In some embodiments, tag node 200 includes one or more accelerometer(s) 210. The accelerometer(s) 210 can be a plurality of accelerometers, each measuring acceleration in a single axes or a multi-axis accelerometer 210 (e.g., a three-axis accelerometer).

### Tilt Sensor

One or more tilt sensors 212 can be arranged to detect the orientation of tag node 200. Tilt sensors 212 can be fabricated by placing a metal ball in a tube and allowing the ball to contact one or more contacts at an end of the tube to complete a circuit. Suitable tilt sensors are available from Adafruit Industries of New York, N.Y. and include the RBS04 and RBS05 Series available from OncQue Corporation of Taichung, Taiwan.

### Anchor Nodes

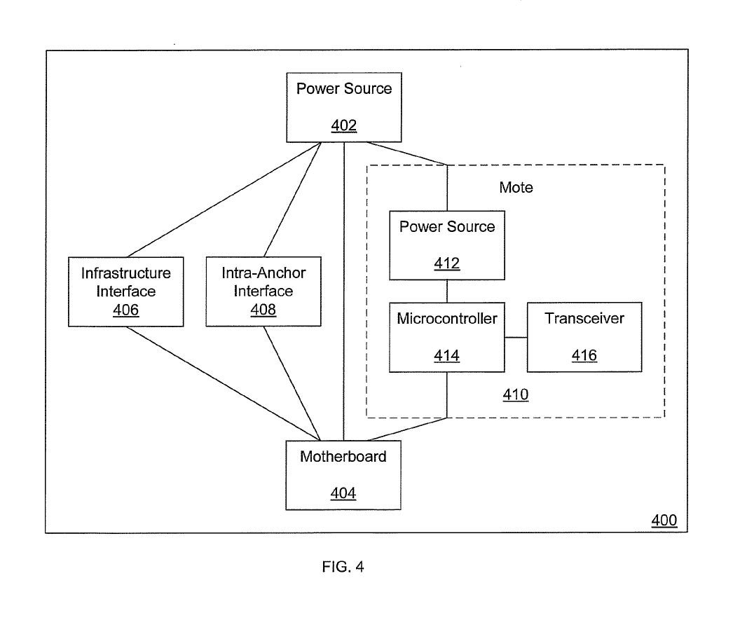

Referring now to FIG. 4, an embodiment of an anchor node 400 is depicted. In some embodiments, an anchor node 400 comprises a power source 402, motherboard 404, an infrastructure interface 406, an intra-anchor node interface 408, and a mote 410.

### Power Source

Power source 402 can include one or more sources of power sufficient for operation of the anchor node components. In some embodiments, the anchor node 400 is connected to an alternating current source (e.g., line voltage). In other embodiments, the anchor node 400 includes or is connected to a direct current source (e.g., a battery). The power source 402 can include one or more solar cells to eliminate the need and expense for hard-wiring the anchor node 400 and/or the need and expense to regularly replace batteries.

### Motherboard

Motherboard 404 is a printed circuit board. In some embodiments, motherboard 404 includes an embedded operating system. Suitable operating systems include, for example: UNIX®, available from the X/Open Company of Berkshire, United Kingdom; FREEBSD™ available from the FreeBSD Foundation of Boulder, Colo.: LINUX®, available from a variety of sources; GNU/Linux, available from a variety of sources; POSIX®, available from the Institute of Electrical and Electronics Engineers (IEEE) of Piscataway, N.J.; OS/2®, available from IBM Corporation of Armonk, N.Y.; MAC OS®, MAC OS X®, MAC OS X SERVER®, all available from Apple Computer, Inc. of Cupertino, Calif.; MS-DOS®, WINDOWS®, WINDOWS 3.1®, WINDOWS 95®, WINDOWS 2000®, WINDOWS NT®, WINDOWS XP®, WINDOWS SERVER 2003®, WINDOWS VISTA®, all available from the Microsoft Corp. of Redmond, Wash.; and SOLARIS®, available from Sun Microsystems, Inc. of Santa Clara, Calif. Operating systems are discussed in a variety of publications including, for example, Andrew S. Tanenbaum, “Modern Operating Systems” (2d ed. 2001). For example, motherboard 404 can be a GUMSTIX®-brand motherboard, available from Gumstix, Inc. of Portola Valley, Calif., with the LINUX® operating system stored in embedded memory.

### Infrastructure Interface

Infrastructure interface 406 enables the anchor node 400 to communicate with other devices (e.g., control device 110) via a network. In some embodiments, the other devices are general purpose computers (e.g., in a police station). Anchor node 400 can communicate with other devices via the wide range of communication technologies and standards now known and later discovered including wired (e.g., twisted-pair, fiber optic, coaxial, and the like), wireless (e.g., IEEE 802.11, IEEE 802.15.4), cellular, and satellite technologies. Embodiments including a IEEE 802.11 (“Wi-Fi”) transceiver are particularly advantageous because Wi-Fi-enabled anchor nodes 400 can access existing Wi-Fi networks including increasingly ubiquitous municipal Wi-Fi networks to avoid the expense of hardwiring the anchor node 400 and the recurring expense for access to a wired network.

### Intra-Anchor Node Interface

Intra-anchor node interface 408 facilitates communication between anchor nodes 400. Anchor node 400 can communicate with other anchor nodes 400 via the wide range of communication technologies and standards now known and later discovered including wired (e.g., twisted-pair, fiber optic, coaxial, and the like), wireless (e.g., IEEE 802.11, IEEE 802.15.4), cellular, and satellite technologies. Embodiments including an IEEE 802.15.4 transceiver are particularly advantageous as such transceivers have ranges of up to 40 miles with a high-gain antenna, thereby allowing messages to hop between anchor nodes 400 if infrastructure network connectivity is not available one or more anchor nodes 400. Suitable IEEE 802.15.4 transceivers include the 9XTend™ OEM RF Module available from Digi International Inc. of Minnetonka, Minn.

In some embodiments, intra-anchor node interface 408 is duty cycled to conserve power. Duty cycling can be accomplished by using manufacturer-implemented configuration such as the Cyclic Sleep mode in the 9XTend™ OEM RF Module. In the Cyclic Sleep mode, the intra-anchor node interface 308 implements a B-MAC style low-power listening mode that draws about 1.6 mA when sleeping and 80 mA (at 5 V) when idle listening. (The B-MAC protocol is described in Joseph Polastre et al., “Versatile Low Power Media Access for Wireless Sensor Networks,” in “SenSys '04: Proc. of the 2^{nd} Int'l Conf. on Embedded Networked Sensor Systems” 95-107 (2004).) The sleep interval is programmable in powers of 2 from 1 to 16 seconds.

Under the assumption of infrequent theft reports and intermittent communications, the average anchor node power budget is expected to fall between 100 and 200 mW. Assuming 5 hours of peak solar radiation each day and a 25% power conversion and battery round-trip storage efficiency, a 5 W solar panel and a small battery with a few amp-hour capacity will be sufficient to power each anchor node 400 continuously.

Each anchor node 400 maintains an estimate of the minimum travel time to its nearest neighbor. Upon receiving a theft report beacon from a tag node 102, the anchor node 400 responds with this travel time estimate, allowing the tag node 400 to sleep for a substantial fraction of this travel time.

In some embodiments, the travel time estimate also includes a digitally-signed message of the travel time plus a nonce supplied by the tag node 102. Signature verification using the RSA algorithm using a 1024 bit signature is possible on the Telos B mote in 0.7 seconds as discussed in Prabal Dutta et al., “Securing the Deluge Network Programming System,” in “IPSN '06: Proc. 5th Int'l Conf. on Information Processing in Sensor Networks” 326-33 (2006).

### Mote

Mote 410 communicates with tag nodes 102. A variety of motes are commercially available. For example, where the tag node 102 includes a 2.4 GHz transmitter 106, suitable motes include the TELOSB™ mote, available from Crossbow Technologies, Inc. of San Jose, Calif.; the EPIC™ mote, available from Arch Rock Corporation of San Francisco, Calif.; the FM1 FlatMesh Digital Node and FM2 FlatMesh Analogue Node available from Senceive Ltd of London, United Kingdom; and the SUN SPOT™ mote available from Sun Microsystems, Inc. of Santa Clara, Calif. Mote 410 can be integrated with motherboard 404 or can be coupled with motherboard 404 with a variety of known technologies including USB, USB 2.0, IEEE 1394 (“FireWire”), serial cable, PCI or PCI-E slots, and the like.

Mote 410 can have a structure similar to tag node 102. For example, mote 410 can include a power source 412, a microcontroller 414, and a transceiver 416. Power source 412 can be distinct from power source 402 so that motherboard 404 can be shut down or placed in a sleep or low power mode while mote 410 remains powered to monitor transmissions from tag nodes 102. Transceiver 416 can be an IEEE 802.15.4 radio transceiver as discussed herein (e.g., a CC2420 transceiver as discussed herein in the context of tag node 200).

### Tag Node Deployment

The process of acquiring and deploying a tag node 102 is designed to keep the cost and user compliance minimal. Users can purchase a tag node 102 over the Internet, receive one or more tag nodes 102 via postal or courier services, follow the arming procedure to arm the tag node 102, hide the tag node 102 in assets 106 of their choice, and forget about the tag node 102. Alternatively, users can purchase tag nodes 102 from a retail store. If and when the user needs to transport a tagged asset 106 out in a vehicle 108, the user can either disarm the tag node 102 or remove the tag node 102 from the asset 106 before moving the asset 106.

Although embodiments of the tag node 102 are designed to last about ten years without recharging, its energy may be exhausted sooner due to factors such as frequent movement of the tag node 102 by the owner or due to being stolen and recovered. Consequently, a profile-based reminder system (similar to car service reminders sent by car dealerships) is provided in some embodiments. An energy profile estimator will be maintained at the service provider, who will use the time elapsed since deployment and time spent in the tracking state if a tag node 102 was stolen and tracked to estimate the remaining lifetime. The owner will be reminded to swap the tag node 102 for a newer tag node 102 with a new battery and possibly improved technology when the estimated lifetime crosses below a certain threshold (e.g., 20%).

### Tag Node Operation

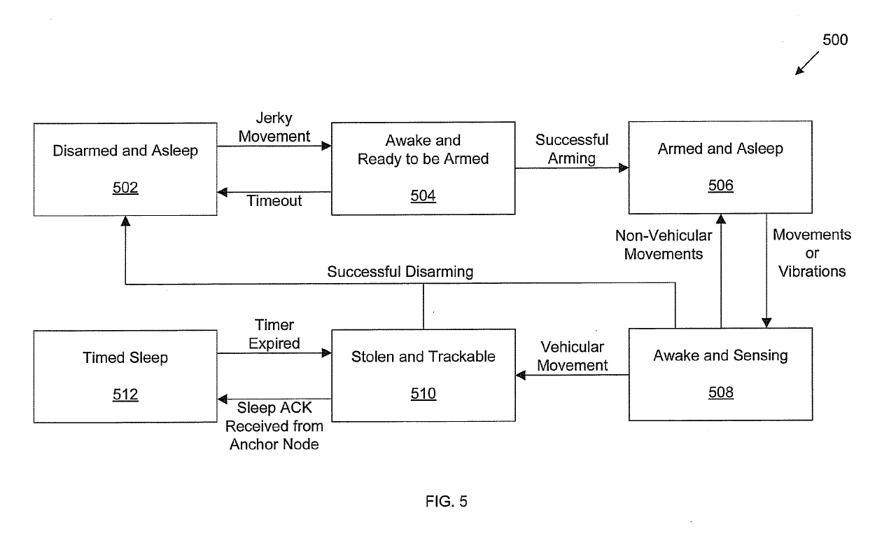

Referring now to FIG. 5, a state transition diagram 500 depicts the operation of tag node 102 according to one embodiment of the invention.

Initially in state 502, a tag node 102 is disarmed and sleeping. When purchased, the tag node 102 can be shipped to a user without raising any theft alarm. Once a user receives the tag node 102, the user arms the tag node 102 before hiding it in an asset 106 that is likely to be taken in the event of a burglary. The process of arming/disarming uses a novel mechanism of entering a multi-character password (e.g., a password chosen by the user while purchasing the tag node 102 online or a password generated automatically by the system) using the tilt sensor 212 or accelerometer 210 in the tag node 100. Further details of the arming/disarming procedure are described in the “Arming and Disarming a Tag Node” section herein.

Once armed, the tag node 102 enters a deep sleep state 506 (with just only motion detector 204 active). Tag node 102 wakes up (state 508) when interrupted by the motion detector 204 as a result of significant movements such as jerks, displacements, and the like.

Once awake, tag node 102 collects further readings of movement using accelerometer 210 and runs a simple and efficient classification algorithm to determine whether it is being carried in a vehicle. Further details of the classification algorithm are described herein. If the tag node 102 is not being carried in a vehicle, the tag node 102 returns to the armed and asleep state 506. Otherwise, tag node 102 enters into the stolen and trackable state 510 and seeks an anchor node 104 to notify a control device 110 of its theft and most recent encounter with an anchor node 104. During this stolen and trackable state 510 state, tag node 102 can run on a 5% duty cycle, while guaranteeing rendezvous with anchor nodes 104 on along the path of the tag node 102. In between communications with successive anchor nodes 104, the tag node 102 goes into a timed sleep mode 512 after having received an estimate of travel time to reach the next anchor node 104 on its path (saving further energy and enhancing the trackable lifetime by five to tenfold). Further details of the tracking algorithm are described herein.

When the stolen assets 106 are recovered, the recovered assets 106 can be returned to the owner, who can disarm (state 502) and rearm (states 504 and 506) the tag nodes 102 again to help catch any future burglar.

### Arming and Disarming a Tag Node

A variety of devices and techniques can be used to arm and disarm the tag node 102. In one embodiment, tag node 102 is armed and disarmed system using of accelerometer 210 and one or more light-emitting diodes (LEDs) without assistance from any buttons and displays.

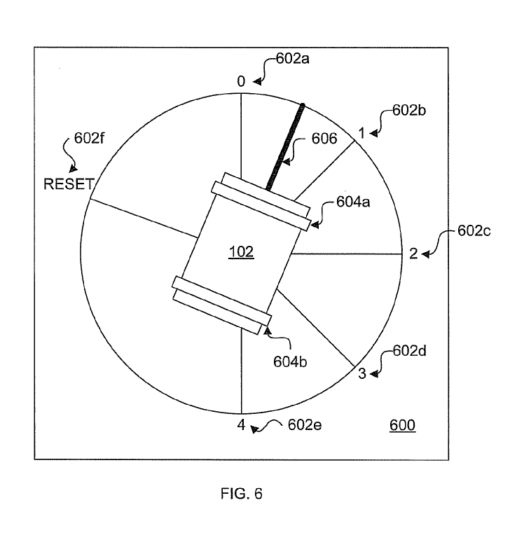

Referring to FIG. 6, a dial 600 is provided with password characters 602a-e marked at various orientations and a reset character 602f. The dial 600 can be constructed from a relatively inexpensive material (e.g., paper, cardboard, plastic, wood, metal, and the like) and can be shipped together with the tag node 102 to the user.

The tag node 102 can be held against the face of dial 600 by a variety of means. For example, one or more bands or straps 604 (e.g., rubber bands) can be attached to dial 600 to hold tag node 102. Alternatively, the tag node 102 can be held against the face of dial 600 by complimentary geometries of the dial 600 and the tag node 102, snap fasteners, hook-and-loop fasteners, screws, bolts, releasable glues, and the like.

In some embodiments, a marker 606 is provided to aid in proper alignment of the tag node 102 with the dial 600. In other embodiments, proper alignment between the tag node 102 and the dial 600 is facilitated by markings on the tag node 102 and/or by the orientation of the means for holding the tag node 102.

Dial 600 can include varying numbers of password characters 602a-e. For example, the dial 600 can include two, three, four, five, six, seven, eight, nine, ten, or more password characters 602. Although six-character passwords are determined to be optimal in Working Example #1 below, variable length passwords (optionally, with a minimum number of characters) can be allowed to enhance the security, as breaking a password will also require guessing the number of digits. Although the total number of password combinations is only in the thousands, the need for physical manipulation of the tag node 102 to enter a password makes and exhaustive search for a password both cumbersome and unlikely. As seen in FIG. 8, upwards of 40 seconds are required to enter a six-character password. Accordingly, about six minutes would be required to attempt only ten potential passwords.

To enter a password, the tag node 102 is awakened from its deep sleep mode (state 502) with a jerk. In some embodiments, an LED confirms the wake-up. Once awake, the tag node 102 is in state 504 and is ready to receive passwords.

It is possible that after a wake-up from a jerk not induced by the user during transit to the user, the tag node 102 may be oriented in certain direction corresponding to a password character 602. Consequently, the password characters 602 may be accepted by the tag node 102 as passwords and if in the rare case that the password matches the arming password, the tag node 102 may be accidentally armed. This may become more likely for shorter (e.g., two- or three-character) passwords. To prevent such scenarios, in some embodiments, the unit must be oriented to the reset mark 602f before entering the password.

A similar and a more serious issue can occur when the tag node 102 is stolen and the orientations experienced by the tag node 102 are accidentally taken as a disarming password. Further, how quickly the tag node 102 is oriented from one direction to the next may vary from user to user. To prevent the tag node 102 from mistaking a prolonged stay in a direction for repeated entries of the same password character, a preamble password character can be required in some embodiments. Before entering any valid character in the password sequence, the tag node 102 must be brought back to the preamble character. Use of a preamble character also helps to make the accidental arming password situation described earlier more unlikely.

In some embodiments, the character ‘0’ is used as a preamble, i.e., before entering any new digit in a password, the tag node 102 must be brought back to the preamble digit ‘0.’ In some embodiments, an LED provides a confirmation when a digit is accepted by the tag node 102. This confirmation is only to indicate that a password character was received by the tag node 102 (like a character entered via keyboard is echoed on the screen to confirm its entry) and is no indication if this character is the correct character in the password sequence. Once all correct characters are entered, a subset of LEDs can be lighted simultaneously to indicate a successful attempt.

In embodiments of the invention in which a tag node 102 is embedded in an asset such as a television (possibly in the factory itself) or is not easily accessible for other reasons, remote entry of password may be useful. Again, to keep the cost low, an accessible tag node 102 may be used to arm/disarm another tag node 102. For example, a tag node 102 could be designated as a “key” and used to enter passwords that would transmitted (e.g., wirelessly over an encrypted channel) to the embedded tag node 102. In another example, a tag node could be inserted into a slot on the asset. Another benefit of using a tag node 102 for remotely entering a password is that breaking a password may require exorbitant time as discussed herein, thus making a brute force attack unlikely.

### Working Example #1

### Optimization of Arming/Disarming Protocol

To determine optimal password parameters, ten participants (mostly students) entered various length passwords to determine the appropriate density of digits on the dial and appropriate length of the password. The study also helped in evaluating the user friendliness of the arming/disarming protocol.

### Determination of Optimal Number of Characters on Dial

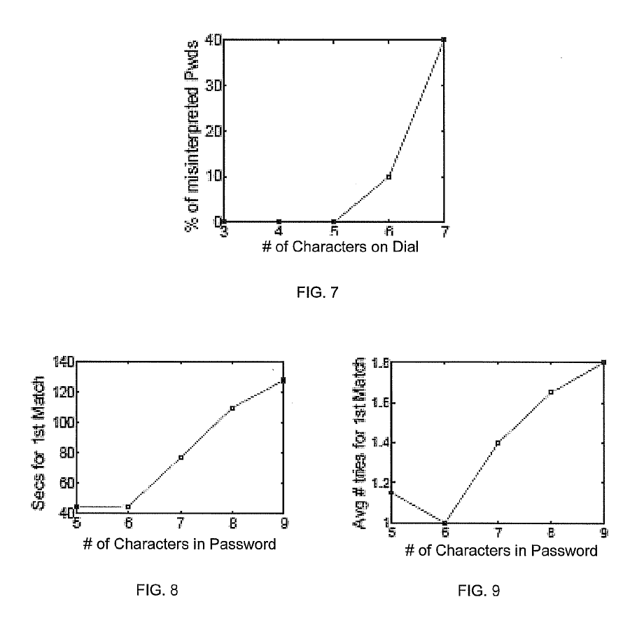

As depicted in FIG. 7, in experiments in which each password was attempted times for each dial configuration revealed that when a half-circle included more than five characters, at least 10% of digits entered were interpreted incorrectly, i.e., the user entered the correct characters 602 in a password sequence but the tag node 102 did not accept the password. With up to five characters, there were no misinterpretations.

### Determination of Optimal Password Length

Each participant was asked to enter passwords varying between five and nine digits. Each participant made multiple attempts until a first success entry for each password. As depicted in FIG. 8, six digits appears to be an optimal password length. The time required to enter more than six digits increases sharply (almost two-fold).

Interviews with participants revealed that participants were able to remember six digit passwords by dividing the six digits into two three-character sub-passwords. However, when entering passwords having seven or more digits, participants had to repeatedly look up the password.

As shown in FIG. 9, every participant was able to enter a correct six-digit password in one attempt. For seven- and nine-digit passwords, the average number of attempts increased by 40% and 80%, respectively. Surprisingly, the number of attempts for five-digit passwords was greater than for six-digit passwords. Again, the participants cited the ease of remembering a six-digit passwords as the possible cause.

### Theft Detection

As discussed herein, tag nodes 102 can be hidden in assets 106 that are usually moved only in a vehicle 108. There are several phenomena that may be used to indicate that a tag node 102 (hidden in an asset 106) is being stolen.

In one embodiment, a tag node 102 can consider itself “stolen” upon being moved while the owner is not present (signaled by the absence of a master key such as a special tag node 102 or a mobile phone within communication range of the tag node 102). This approach would require the programming of a mobile phone and establishing compatible communication with various types of mobile phones. If a special tag node is used, then the special tag node must be carried by anyone wishing to move a tagged asset 106 from one room to another.

In another embodiment, a tag node 102 can consider itself stolen when the tagged asset 106 is taken outside of a marked zone. Such an approach requires use of some positioning technology (e.g., GPS, GPRS, and the like). Additionally, the user would need to update the system anytime the user moves to a new dwelling.

In still another embodiment, movement in a vehicle 108 serves as an indicator of a theft event if the tag node 102 has not been disarmed. Vehicle-movement-based theft detection is advantageous for at least two reasons. First, delaying the transition to state 510 (wherein the tag node 102 attempts to communication with anchor nodes 104) until the tagged asset 106 is moving in a vehicle 108 on a road preserves battery life while burglars may be collecting other items. Second, delaying communication allows the tag node 102 to evade detection by radio frequency (RF) scanners that may be used by sophisticated burglars.

In some embodiments, a tag node 100 does not consider itself “stolen” until it is driven in a vehicle 108 (as opposed to being carried by hand, for example when carried in an elevator or stairs). Such a tag node 102 would not send any message until the burglar has collected all assets of interest and begin to drive their vehicle 108. At this point, even if the burglar's RF scanner detects the radio transmission, it may be too late and the burglar may have invested too much effort into the burglary to abandon the attempt. Even if the burglar does attempt to unload his vehicle 108, unloading may be too cumbersome and the tag node 102 may haven been detected by some anchor node 104 during transportation.

A variety of classification algorithms exist to distinguish various human activities such as driving or riding in a motor vehicle from jogging, walking, and the like. See J. Lester et al., “A hybrid discriminative/generative approach for modeling human activities,” in “Proc. Int'l Joint Conf. on Artificial Intelligence” (2005). These algorithms make use of extensive machine learning techniques to automatically select the best features from a hundreds of features computed. These algorithms, however, require processing power of at least a mobile phone class device.

Since only classification of vehicle movement from all other types of movements is desired, a simple classifier is adopted in some embodiments. To obtain an algorithm that is efficient and accurate, a simple algorithm is first used to classify segments of about 250 ms either as:
static (S)—the tag node 102 is not moving;
walking (W)—the tag node 102 is being carried by a walking person; and
driving (D)—the tag node 102 is in a moving vehicle 108.
   To improve the accuracy of this simple classifier, this classifier is inserted into a simple sequential decision algorithm, inspired by the Sequential Probability Ration Test (SPRT). Let Cₜε{S,W,D} denote the decision of the simple classifier in segment t. Note that Cₜ is a random variable. Note also that the tag node 102 is assumed to have is woken up at the beginning of each segment. This should not constitute a loss in generality, the periods between wake-up signals are assumed to be long compared to T.

When a tag node 102 is woken up (state 508) at the beginning of segment t, it immediately samples the accelerometer 210 for about 250 ms and computes Cₜ. If Cₜ=S, the tag node 102 goes back to sleep (state 506). The logic behind this approach is that, if the tag node 102 is in a static vehicle 108, the tag node 102 will be woken up at a later time, when the vehicle 108 accelerates and otherwise no theft is occurring. This rule reduces the classification to a binary decision, between driving and walking. To make this decision, a sequential test that is based on the Sequential Probability Ratio Test (SPRT) is used.

Let H_{D} denote the null hypothesis that the tag mote is in a moving car, and H_{W} the alternative hypothesis that the tag mote is being carried by a walking person. For each time i, let cᵢ be the observed classification of segment i, and pᵢ^{D} be defined as P(Cᵢ=cᵢ|H_{D}) and pᵢ^{W} be defined as P(Cᵢ=cᵢ|H_{W}). According to the SPRT algorithm, a decision should be made at time s≧t, as soon as one of the following conditions is met:

$${\sum }_{i = k}^{s} [ log ( {p}_{i}^{D} ) - log ( {p}_{i}^{W} ) ] \geq {a}_{D} \to declare driving ;$$

$$or$$

$${\sum }_{i = k}^{s} [ log ( {p}_{i}^{D} ) - log ( {p}_{i}^{W} ) ] \leq {a}_{W} \to declare walking .$$

The thresholds a_{D} and a_{W} are designed to achieve desired probabilities of false alarm and misdetection.

Obtaining the probabilities involved in this decision rule is not trivial. In fact, the measurements might not be independent and identically-distributed under the different hypothesis, which precludes the optimality of the SPRT method. Thus, the SPRT algorithm is used as a guide to obtain the following decision rule:

α_{D}|A_{s,t}^{D}|−α_{W}|A_{s,t}^{W}|≧a_{D}→declare driving; and

α_{D}|A_{s,t}^{D}|−α_{W}|A_{s,t}^{W}|≧a_{W}→declare walking;

where A_{s,t}^{D}{i|cᵢ=D,i=t, . . . , s} and A_{s,t}^{W}{i|cᵢ=W,i=t, . . . , s}. Parameters α_{D}, α_{W}, a_{D} and a_{W} are regarded as design parameters. Choosing α_{D}=α_{W}=1, a_{D}=2, and a_{W}=−2, defines the simple rule that, if two consecutive segments are classified as “walking,” then the algorithm declares that the tag node 102 is being carried by a walking person, while, if two consecutive segments are classified as “driving,” then the algorithm declares that the tag node 102 is in a moving vehicle 108.

Notice that the SPRT algorithm outputs a decision only when one of the two thresholds is reached. It might be the case that such thresholds are reached only after a long time. Such a case is regarded as a small probability event and accounted for by setting a maximum time, after which, if no threshold has been reached, the algorithm declares that no theft is occurring, and the tag node 102 goes back to sleep (state 506). The “no theft” decision can be favored to reduce false alarms and because it is expected that, if a theft is not caught immediately, as the vehicle 108 drives on, the tag node 102 will be woken up often enough to detect the theft at a later time.

To further reduce the number of false alarms, an additional rule can be added to the algorithm. Before declaring that a theft is in progress, the tag node 102 can sleep for a certain period of time T′. After waking up again after T′ seconds or after being woken up by the accelerometer before T′, if the tag node 102 detects a theft for the second time, only then does the tag node 102 issues an alarm. Otherwise, the tag node 102 restarts the algorithm and sleeps.

Embodiments of the initial classifier are now described in greater detail. A feature or set of features is selected that can be used to distinguish between a driving car and a walking person and an algorithm is provided to classify each segment based on such features.

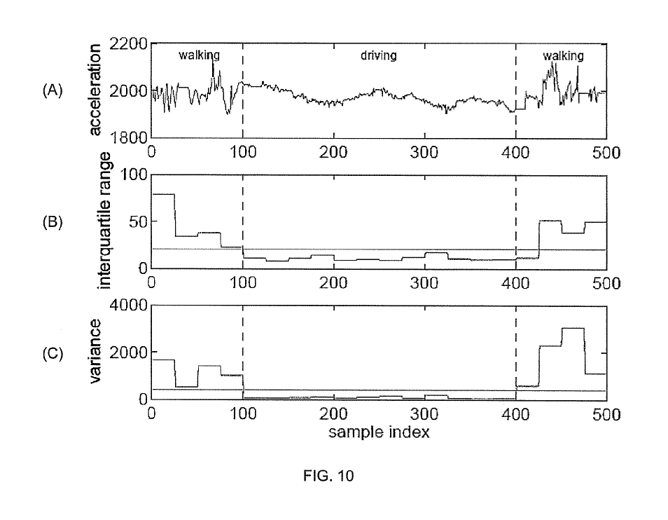

FIG. 10A depicts the acceleration signal obtained when a person takes an asset 106 containing a tag node 102 from the ground, walks with it, puts the asset 106 in a vehicle 108, drives the vehicle 108, takes the asset 106 from the vehicle 108, walks with the asset 106, and finally deposits the asset 106 on back on the ground.

FIGS. 10B and 10C depict the interquartile range and the variance, respectively, of a signal obtained from the acceleration measurements by computing the first difference, and then removing all the differences that are zero. The rationale behind performing this transformation before computing the features is that walking produces large and fast variations in acceleration, while driving produces slower, sustained variations, and computing the first difference will accentuate such difference.

As depicted in FIG. 10C, variance provides for a better separation. Experiments have shown that variance continues to provide for sufficient separation even when the accelerometer 210 is not oriented to the direction of movement. In some embodiments, accelerometer 210 is be “reoriented” to the direction of movement in accordance with the techniques of Prashanth Mohan et al., “Nericell: Rich Monitoring of Road & Traffic Conditions using Mobile Smartphones,” in “Proc. 6th ACM Conf. on Embedded Network Sensor Systems” 323-36 (2008).

### Anchor Node Deployment

In some embodiments, anchor nodes 104 are sparsely deployed in a road network that provides guarantees on the frequency of detection of a moving stolen tag node 102. The problem of anchor node deployment is defined formally as an NP-hard graph theory problem and a new approximation algorithm is provided that ensures the detection guarantee for tag nodes 102 and that each anchor node 104 can reach the Internet backhaul (possibly via multiple wireless hops in the anchor node network). Simulation results on two real-life road networks to demonstrate the algorithm's performance (including the number of wireless hops needed to reach the Internet).

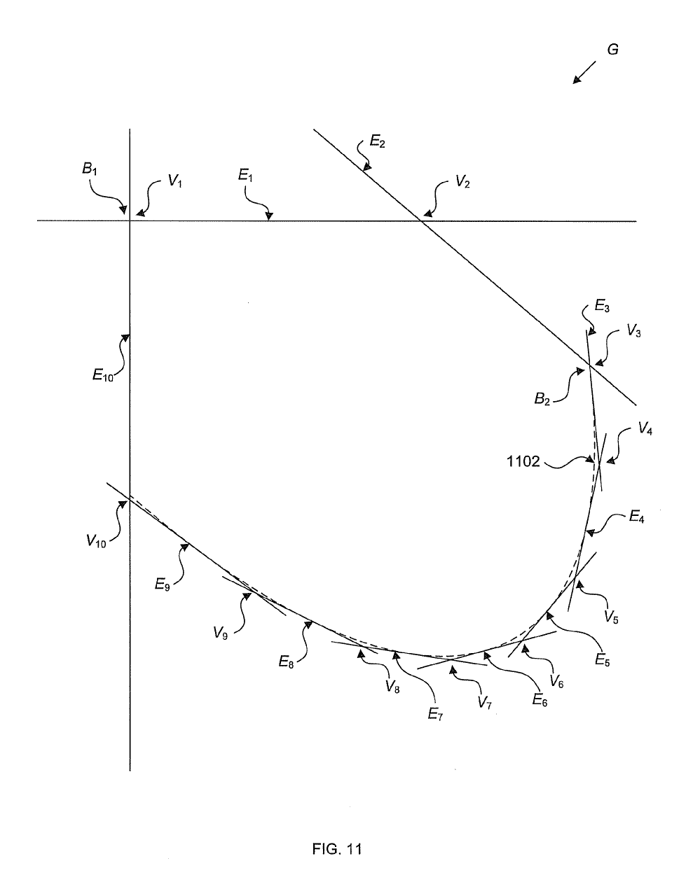

Referring now to FIG. 11, a road network R is modeled as a connected undirected geometric graph G=(V, E), where vertices represent points where road centerline segments and road intersections meet, and edges represent road centerline segments connecting road intersections. For a curved road segment 1102, one or more artificial road intersections V₃-V₁₀ are introduced so that each edge represents a straight line segment. This model has been used by some publicly available road network databases such as TIGER® system available from the U.S. Census Bureau of Washington, D.C. Such artificial road intersections V₃-V₁₀ can, in some embodiments, be introduced at the location of utility poles on curved road 1102 as such utility poles can be ideal locations for mounting anchor nodes 104.

It is assumed that anchor nodes 1104 can be deployed at all the road intersections V and possibly at some other points in graph G. By regarding these extra points as artificial road intersections V, one may simply assume that every vertex V of graph G is a candidate location for deploying anchor nodes 104. In the embodiments described herein, a homogeneous deployment is assumed wherein each anchor node 104 has the same sensing range r and communication range R, and r [symbol] R. Again, by introducing artificial intersections V, one may safely assume that the length of each edge in G is at most min(R, x), where x is the coverage diameter defined below. It is further assumed that the set of gateways with Internet backhaul are located at B [symbol] V with communication range R. Let H(V_{H}, E_{H}) denote the communication graph where V_{H}=V and there is an edge between a,bεV_{H} if their Euclidean distance d(a, b)≦R. Note that G is a subgraph of H.

The trajectory of a moving vehicle 108 is modeled as a set of consecutive paths on G starting and ending at any points (not necessary vertices) on G. A path f is covered by an anchor node if it goes through the corresponding point on G where the anchor node is deployed. Since r [symbol] R, it is reasonable to model a deployed anchor node 104 as a point. For any two points a, b on G, let dist(a, b) denote their graph distance, that is, the length of the shortest path over G connecting the two points, and let F_{ab} denote the set of all possible paths connecting a and b.

As used herein, a deployment of anchor nodes 104 provides “Section Coverage with diameter x” if (i) for any pair of points (a, b) on G with dist(a, b)≧x, any path fεF_{ab} is covered by at least one anchor node and (ii) each anchor node is connected to at least one Internet gateway (possibly via multi-hop wireless links).

Note that if Section Coverage is provided, then (i) a tag node that moves an absolute displacement beyond x is guaranteed to be captured by at least one anchor node and (ii) such events can be forwarded to a gateway through multi-hop wireless networks. The parameter x provides a tradeoff between coverage quality and the cost of deployment and management. An optimal deployment that provides Section Coverage while using minimum number of anchor nodes is preferable.

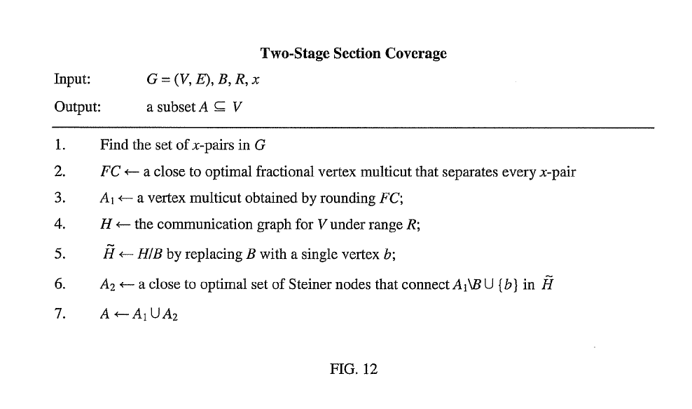

The Section Coverage problem is NP-hard. The approximation algorithm provided herein by decomposes the problem into the coverage and connectivity subproblems. The entire solution is summarized in FIG. 12. The approximation factor from the two subproblems can be combined to produce an approximation factor for the joint problem.

### Coverage Subproblem

Given G and x, the coverage subproblem looks for a subset A₁ [symbol] V of minimum size such that the coverage requirement is satisfied. A factor O(log n) approximation to this problem is given in Z. Zheng et al., “Alpha Coverage: Bounding the Interconnection Gap for Vehicular Internet Access” in “IEEE INFOCOM Miniconference (2009) where n=|V| by showing a reduction from the coverage problem to the minimum Vertex Multicut problem as follows. First, a pair of edges (e₁, e₂) is called an “x-pair” if there exist two points p₁ and p₂ on the two edges respectively such that dist(p₁, p₂)=x. Suppose there are k x-pairs in G. Let sᵢ and tᵢ denote the middle points of the corresponding edges in the ith x-pair, 1≦≦k. These points are designated as “terminals.” Regarding all of the terminals as artificial intersections, a new graph is obtained with vertex set V̅=V∪_{1≦≦k} {sᵢ,tᵢ}. A subset A₁ [symbol] V satisfies the coverage requirement if and only if A₁ forms a vertex multicut with respect to the set of terminal pairs, that is, if we remove A₁ (and the edges incident to them) from the new graph, then for each i, sᵢ and tᵢ are in different connected components in the remaining graph.

The minimum vertex multicut problem is a variation of the minimum (edge) multicut problem. The fractional version of the latter is the dual of the maximum multicommodity flow problem. The GVY algorithm described in N. Garg et al., “Approximate Max-Flow Min-(Multi)Cut Theorems and Their Applications,” 25 SIAM J. Comput. 235-51 (1996) is adapted to the vertex multicut problem. The GVY algorithm involves two steps. In the first step, the fractional minimum multicut problem is solved. Although this problem is polynomial time solvable by formulating it as a linear program, it is very time consuming to find an accurate solution for a large road network, especially in the case where k−the number of terminal pairs (the number of commodities in the dual problem)−equals to m² in the worst case, where m=|E|. To reduce time complexity, the combinatorial FPTAS algorithm proposed in S. Guha & S. Khuller, “Improved Methods for Approximating Node Weighted Steiner Trees and Connected Dominating Sets,” 150 Information & Computation 57-74 (1999), which computes a (1−4ε)OPT solution to the maximum multicommodity flow problem in

$$O ( \frac{1}{{ɛ}^{2}} m ( m + n log m ) log n )$$

time, is applied. It is important to notice that the running time is independent of k. In the second step, the fractional solution is rounded through a low diameter graph decomposition technique, which introduces an extra O(log n) factor. Both steps can be adapted to the vertex version and the entire algorithm has an O(log n) approximation factor.

### Connectivity Subproblem

Given H, B, and [symbol] ₁ computed by the coverage subproblem, the connectivity subproblem looks for a subset [symbol] ₂ [symbol] V\ [symbol] ₁ such that for any aεA₁∪A₂, there is a path in H from a to at least one bεB, and | [symbol] ₂| is minimized. This problem can be reduced to the Node Weighted Steiner Tree Problem as described in S. Guha & S. Khuller, “Improved Methods for Approximating Node Weighted Steiner Trees & Connected Dominating Sets,” 150 Information & Computation 57-74 (1999) with unit node weight as follows. First, given a connected undirected graph G=(V, E) where each vertex has a positive weight, and a subset T [symbol] V, the Node-Weighted Steiner Tree Problem (NSTP) asks for a subset S [symbol] V\T, such that the subgraph induced by S∪T is connected and the total weight of S is minimized. The vertices in T are called terminals, and the vertices in S are called Steiner points. Note that the weight of terminals does not count. Define \tilde{H}=H/B, that is, \tilde{H} is constructed from H by replacing the vertices in B by a single vertex b incident to all the edges which were incident in H to at least one element in B. J. A. Bondy & U. S. R. Murty, “Graph Theory” (Graduate Textbooks in Mathematics Series 2008). It is observed that the connectivity problem in H is equivalent to NSTP with unit node weight and terminals A₁\B∪{b} in \tilde{H}.

The general NSTP problem is harder than the (edge weighted) Steiner Tree Problem (STP) since the latter allows a constant factor approximation while the best known lower bound on the approximation factor for NSTP is O(ln k) where k=|T|. P. Klein & R. Ravi, “A Nearly Best-Possible Approximation Algorithm for Node-Weighted Steiner Trees,” 19(1) J. Algorithms 104-15 (1995). For unit disk graph, however, a factor 2:5ρ approximation is obtained in F. Zou et al., “Two Constant Approximation Algorithms for Node-Weighted Steiner Tree in Unit Disk Graphs,” in “Proc. COCOA 2008” 278-85 (2008) by reducing NSTP to STP and applying a factor ρ algorithm to STP. The algorithm makes use of a key property proved in D. Chen et al., “Approximations for Steiner Trees with Minimum Number of Steiner Points,” 262 Theoretical Comp. Sci. 83-99 (2001): for a unit disk graph, there is an optimal node weighted Steiner tree such that the degree of each vertex in the tree is at most five. The same argument can be applied to all the vertices of \tilde{H} except b, where the degree can be as large as 5|B|. However, since b is a terminal, its weight does not count. Hence the algorithm can be applied to \tilde{H} with the same factor retained, which can be as low as

$$2.5 \times ( 1 + \frac{ln 3}{2} ) \approx 3.88 .$$

### G. Robins & A. Zelikovsky, “Improved Steiner Tree Approximation in Graphs,” in “Proc. 11th Annual ACM-SIAM on Discrete Algorithms” 770-79 (2000).

### Combined Approximation Factor

Suppose the coverage subproblem and the connectivity subproblem can be approximated in a factor δ₁ and δ₂, respectively. The following lemma show how these approximation factors can be combined to obtain an approximation factor for the joint problem.

LEMMA—The two-stage algorithm yields a (δ₁+μδ₁δ₂) approximation for the Section Coverage problem, μ=2([x/R]−1).

PROOF—The following proof is similar to the analysis given in A. Srinivas et al., “Mobile Backbone Networks—Construction and Maintenance,” in “Proc. 7th ACM Int'l Symp. on Mobile Ad Hoc Networking & Computing” 166-77 (2006). Let A₁ and A₂ denote the set of anchor nodes found by solving the coverage subproblem and the connectivity subproblem, respectively. Let [symbol] = [symbol] ₁∪ [symbol] ₂. Since [symbol] ₁ and [symbol] ₂ are disjoint, we have | [symbol] |=| [symbol] ₁|+| [symbol] ₂|≦δ₁OPT_{cov}+δ₂OPT_{con}, where OPT_{cov} and OPT_{con} denote the size of an optimal solution to the coverage subproblem and the connectivity subproblem given A₁ as input, respectively.

Given [symbol] ₁, a (suboptimal) solution to the connectivity subproblem can be obtained by a growing process as follows. Initially, let S= [symbol] . At each step, find a vertex aε [symbol] ₁\U that is closest (in terms of the graph distance in [symbol] ) to S Let f denote a corresponding shortest path. Note that the length off is at most x since [symbol] ₁ satisfies the coverage requirement. Hence by deploying at most μ=2(┌x/R┐−1)² extra anchor nodes along f, a can be connected to an element in [symbol] . Add a and the vertices on f corresponding to the extra anchor nodes to S Repeat this process until all the elements in [symbol] ₁ are connected to [symbol] . This process gives a solution to the connectivity subproblem that uses at most μ| [symbol] ₁| extra anchor nodes. Hence OPT_{con}≦μ| [symbol] ₁|.

Let OPT denote the size of an optimal solution to the Section Coverage problem. It is clear that OPT_{cov}≦OPT. Thus:

|A|≦δ₁OPT_{cov}+δ₂(μ|A₁|)≦(δ₁+μδ₁δ₂)OPT_{cov}≦(δ₁+μδ₂)OPT.

From the lemmas and the approximation factors of the above algorithms for each subproblem, the two stage algorithm for the Section Coverage problem has an approximation factor

$$O ( \frac{x}{R} log n ) where n = \vert 𝒱 \vert .$$

### System Operation

Once anchor nodes 104 are deployed in a city to provide Section Coverage and tag nodes 102 are armed and hidden in assets 106 of choice by users as discussed herein, the system 100 is active and ready to autonomously detect burglary and help lead to the arrest of the burglar. The goal of the system 100 is to eventually lead to the arrest of the burglars, not to deter them so that the burglars select a more vulnerable neighboring property in the neighborhood. This section discusses how the system 100 detects a burglary event and provides real-time updates on the current location of suspects while conserving energy even while the tag node 102 is being tracked in real-time.

Anytime a tag node 102 determines that it is “stolen,” the tag node 102 begins to search for an anchor node 104 to notify the control center 110 (e.g., in the office of a law enforcement agency or a third party) and to provide the most recent encounter of the tag node 102 with an anchor node 104. Deployment of anchor nodes 104 to provide Section Coverage ensures that any stolen tag node 102 will be detected by an anchor node 104 in every distance x that the tag node 102 moves on the road network. Also, Section Coverage provides a section location in which a moving stolen tag node 102 is guaranteed to be in. Police officers and/or police vehicles can carry an anchor node 104 or a variant thereof with which the police can scan a given section to pinpoint the precise location of a stolen tag node 102 even if the tag node 102 may not be moving anymore.

In this section, several simple energy efficient mechanisms that enhance the trackable lifetime of the tag node 102 by several orders of magnitude over an alternative approach when the tag node 102 is always active while being tracked, while ensuring that a stolen tag node 102 is missed rarely, if ever, by an anchor node 104 with which it has an encounter. Energy efficiency during the tracking mode is emphasized because a tag node 102 may have low energy remaining when it is stolen and it must conserve as much energy as possible to maximize its chances of being tracked and recovered by lengthening the tag node's lifetime.

### Leveraging Sparse Deployment

Since the deployment of anchor nodes 104 is sparse, a tag node 102 can safely sleep (state 512) in between meeting two successive anchor nodes 104, if the tag node 102 can reliably estimate the time taken to travel between the anchor nodes 104. The anchor nodes 104 maintain the current estimate of time taken to reach to the nearest anchor node 104 from the data available over the Internet and provide this information in the acknowledgement to tag nodes 102 in response to their beacons, thus making dual uses of the acknowledgment. Even if the actual travel time is 20% longer than the live estimate obtained from the Internet in most cases, the trackable lifetime can be further enhanced by five times since the tag node 102 will be in deep sleep during this interval. Experimental data demonstrating the ability of tag nodes 102 to sleep while still communicating with anchor nodes 104 is discussed in Working Example #5.

### Mitigating Congestion

In some cases, several tag nodes 102 may be stolen together, or in some rare cases, several tag nodes 102 carried in different vehicles may pass by an anchor node 104 simultaneously. In such cases, if all tag nodes 102 attempt to get a response from the anchor node 104, some of them may not be detected. Also, congestion may prevent several tag nodes 102 from receiving a sleep acknowledgement, thereby reducing their trackable lifetime. Although lack of time synchronization helps reduce congestion naturally, it may not be enough.

Tens of hours of real-world driving experiments were conducted to measure the extent of congestion and the effect of various approaches in mitigating it. Fifty tag nodes 102 were carried together in the trunk of a vehicle 108, each of which was on a 5% duty cycle searching for an anchor node 104. The number of tag nodes 102 that were active during a driving instance was varied from 1 to all 50. One anchor node 104 was deployed on the roadside to respond to beacons received from the tag nodes 102 with sleep acknowledgment.

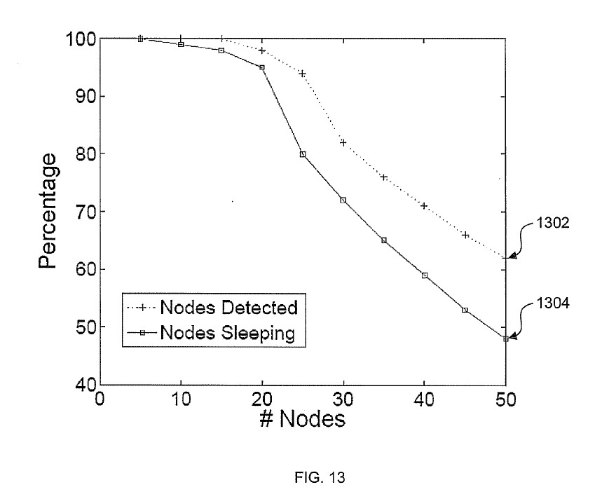

FIG. 13 shows that when each tag node 102 transmits a beacon of its own and sleeps only when it receives a response from the anchor node 104 to its own beacon, more than 50% of tag nodes 102 do not receive a sleep acknowledgement from the anchor node 104. Also, more than 30% of tag nodes 102 were not detected by the anchor node 104 due to congestion. Even when only ten tag nodes 102 were traveling together, some tag nodes 102 miss the sleep acknowledgement.

To mitigate congestion, two techniques were employed. The first technique involved the organization of tag nodes 102 into groups and the second technique involved a windowed multiple group acknowledgement. Observe that it is sufficient for the police to learn the identity of the owner whose asset(s) 106 is stolen; knowledge of each asset 106 that may have been stolen together may not be needed. Hence, all tag nodes 102 owned by an owner can assigned a common five byte group ID (allowing for a trillion unique groups). In addition, three bytes can be used for a tag node ID, allowing for sixteen million nodes to be assigned to a common group.

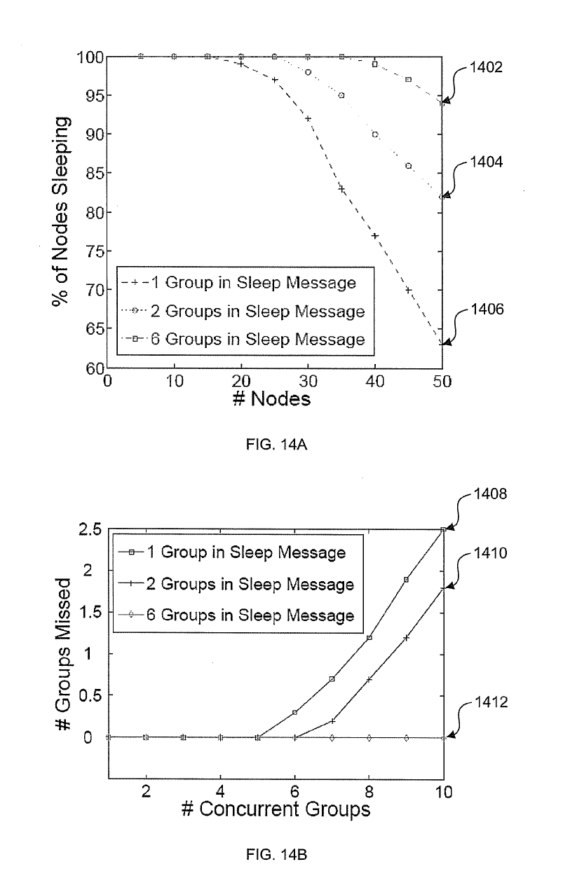

An anchor node 104 acknowledges each beacon message received with a sleep acknowledgement that contains the group ID. This message is sent to a broadcast address so that all awake tag nodes 102 receive it. Any tag node 102 who receives a sleep acknowledgement with its group ID in it treats the sleep acknowledgement as an acknowledgement for itself, irrespective of whether it may have sent a beacon message or not. Introducing a group ID significantly reduces congestion. A comparison of curve 1302 in FIG. 13 with curve 1406 in FIG. 14A demonstrates that 17% more tag nodes 102 are able to receive a sleep acknowledgement. However, if 20 or more tag nodes 102 are traveling together some tag nodes 102 still miss the sleep acknowledgement. The number of tag nodes 102 missing the sleep acknowledgement is still more than 30% for 50 nodes traveling together as represented in curve 1406 in FIG. 14A.

In addition, when the number of groups of tag nodes 102 traveling together is five or more and if there is a small group consisting of only one tag node 102, this single tag node 102 is often not detected by the anchor node 104. Curve 1408 in FIG. 14B shows the mean number of groups that are not detected by an anchor node 104 when several groups of tag nodes 102 are traveling together if only one group is acknowledged at a time. In the extreme case of ten groups of tag nodes 102 including the group consisting of a lone tag node 102, on average 2.5 single tag node groups are not detected by an anchor node 104.

There are several alternatives to address this congestion. In one embodiment, the tag nodes 100 are synchronized and elect a leader for each group that would communicate with the anchor node 104 on the group's behalf.

Alternatively, anchor node 104 can acknowledge multiple groups of tag nodes 102 in the sleep acknowledgement. A window of six groups can be maintained in each anchor node 104 to reflect the most recent six groups that the anchor node 104 has acknowledged. There can be sufficient space in the sleep acknowledgement message body to fit six group IDs. Although coding techniques may be used to pack more groups, six groups was determined through experimentation to be sufficient even when up to 10 groups are traveling together to guarantee that all groups (even small groups) are detected at the anchor node 104 as depicted in FIG. 14A and most nodes are able to sleep as depicted in FIG. 14B.

### Improving Travel Estimate Using Embedded Accelerometer

Although the travel time to reach the next nearest anchor node 104 from the current anchor node 104 can be obtained from the Internet, there may sometimes be large variations due to traffic jams, accidents, and the like. In such cases, stolen tag nodes 102 may spend significant time in search state 510 while the vehicle 108 is stuck in a traffic jam. A simple estimate of the time that a tag node 102 spends in stationary state (i.e., when the vehicle 108 is stationary) can help improve the estimate of the travel time to reach the next anchor node 104. More sophisticated estimates of vehicle speed can improve the estimate further.

### Pinpointing the Suspect Vehicle

Once police begins to chase the suspect and look for the suspect vehicle 108, the anchor nodes 104 may be instructed to not provide any sleep duration in their acknowledgement message. Without sleep instructions, the tag nodes(s) 102 will be reachable quickly if a police vehicle is in the communication range of the tag node(s) 102.

### Working Example #2

### Evaluation of Classification Algorithm

An embodiment of the classification algorithm was tested by placing a three-axis accelerometer in a box and walking and driving with the box. The accelerometer was exposed to a variety of motions including walking and driving in a parking lot and on a street, accelerating, decelerating, and turning.

To test the algorithm with MATLAB® software (available from The MathWorks, Inc. of Natick, Mass.), the algorithm was run on the recorded data sequences by randomly identifying 20 times at which a tag node 102 might have woken up (i.e., times at which the acceleration was large) and executing the algorithm starting at those times. The classification given by the algorithm was then compared with the ground truth obtained by visual inspection.

Using 5 data sequences containing walking and driving events, and choosing 20 instants in each data sequence to initiate the algorithm for the data sequence, it was found that the algorithm classified the segments correctly 96% of the time. The high accuracy, using a simple feature such as the variance, and a simple classification algorithm comes at the price of a longer delay in classification. It was observed that the algorithm required measurements of about two segments (i.e., 500 ms) to detect walking patterns and required measurements of up to ten segments (i.e., 2,500 ms) to classify driving segments.

Although this result is encouraging, the data was taken in a controlled environment and might not represent all possible situations. Particularly, if the object containing the accelerometer is transported in a trolley pushed by a person, rather than being carried by the person herself, the resulting acceleration signature is similar to the one corresponding to driving, and thus, other features might be desirable to treat such cases.

### Working Example #3

### Evaluation of Section Coverage

Embodiments of the solution to Section Coverage were evaluated via simulations over two real-life road networks retrieved from the 2008 TIGER/LINE® shape files, available from the U.S. Census Bureau of Washington, D.C., to understand its performance, including the number of anchor nodes required to cover medium sized road networks and the impact of the number and distribution of gateway locations.

### Baseline Algorithm

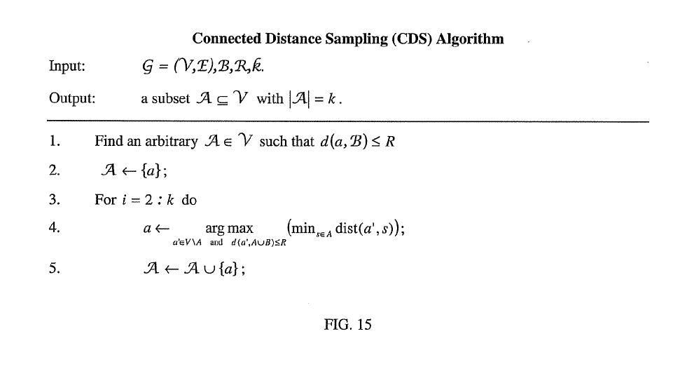

The two-stage Section Coverage algorithm is compared with a simple greedy heuristic called Connected Distance Sampling (CDS), which extends the Max-Min Distance Sampling algorithm by also considering connectivity. See Shang-Hua Teng, “Mutually repellant sampling,” in “Minmax & its Applications” 129-40 (Ding-Zu Du & Panos M. Pardalos eds. 1995). Given a budget of anchor nodes, the algorithm tries to maximize the minimum mutual (graph) distance between anchor nodes while satisfying the connectivity requirement. (The CDS algorithm is depicted in FIG. 15) where d(a, S) denotes the minimum Euclidean distance between a and any element in set S. Note that once the first node is selected, the entire deployment is fixed.

### Simulation Setting

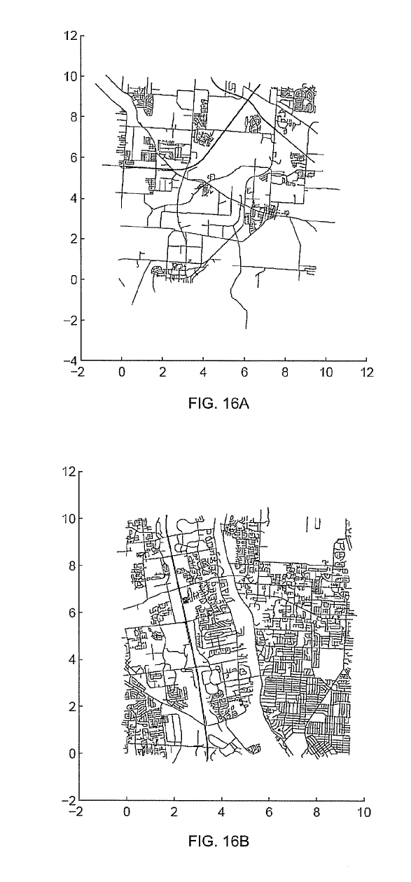

Two road networks spanning 10 km² areas of different densities are considered as depicted in FIGS. 16A and 16B. FIG. 16A depicts a sparse road network with about 2,000 road intersections and about 2,350 road segments. FIG. 16B depicts a dense road network with about 4,600 road intersections and 5,500 road segments. For the sparse network, ε=0.05 was chosen to yield greater accuracy. For the dense network, ε=0.1 was chosen to reduce running time. The communication range R of anchor nodes was fixed to be 1000 m, while the value of x and the number and distribution of gateways was varied. For a given number of gateways, five random gateway deployments were generated. For a given anchor node deployment computed by our algorithm, the CDS algorithm was applied to compute ten different deployments using the same number of anchor nodes.

### Simulation Results

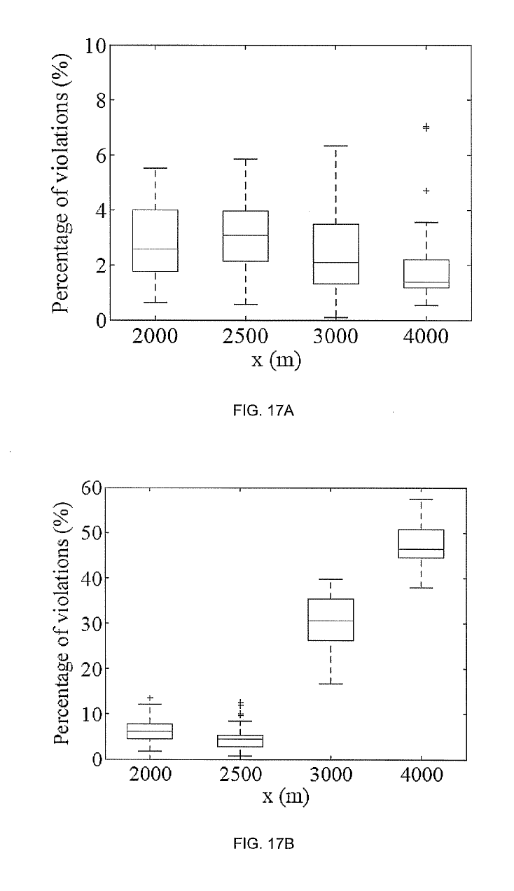

Although the two algorithms use the same number of anchor nodes, the CDS algorithm can only guarantee connectivity but not Section Coverage. FIGS. 17A and 17B show the percentage of x-pairs that are not covered by the CDS algorithm under various x in sparse networks (FIG. 17A) and dense networks (FIG. 17B). The number of gateways is fixed at 10. The result is averaged over 10 different anchor node deployments for each of the 5 gateway deployments.

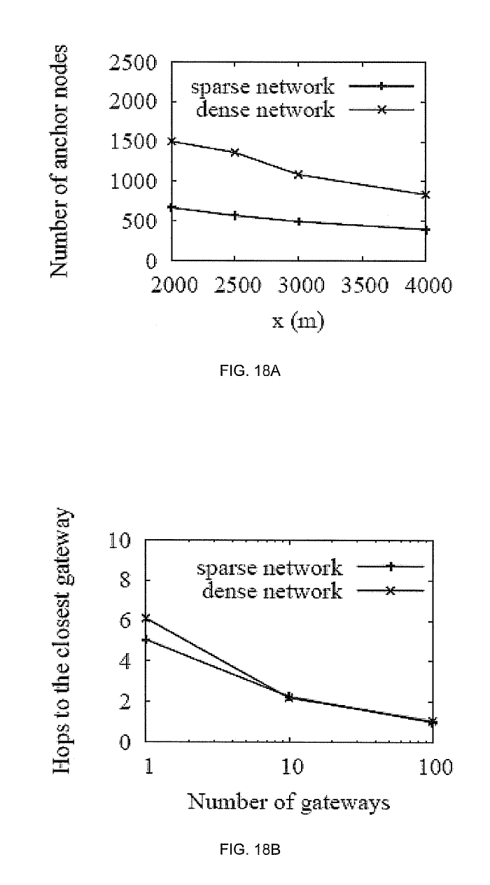

The number of anchor nodes used for the Section Coverage algorithm under various x-values is shown in FIG. 18A. This number is almost independent of the number and distribution of gateways for the parameters evaluated. This number is dominated by the coverage portion of the two-stage algorithm, and the connectivity stage only introduces very few extra anchor nodes, even when x=4000 m and there is only one gateway. This is mainly because of the strict coverage requirement and the approximation factors in the algorithm. Furthermore, the algorithm did not consider the number and distribution of gateways in the coverage stage. However, the number of gateways has a big impact on the average number of hops that each anchor node is away from the closest gateway as shown in FIG. 18B, which in turn affects the communication delay significantly. When x=2000 m, ten gateways are sufficient to achieve an average hop distance of less than three in both networks.

### Working Example #4

### Optimizing the Duty Cycle in Search Mode

To determine an optimal duty cycle that a tag node 102 can operate to enable the tag node 102 to save energy while actively searching for an anchor node 104, three experiments were conducted. The experiments were conducted at the largest urban intersection (where each road has eight lanes at the intersection) in Memphis, Tenn. The first experiment was conducted to determine the minimum contact time a moving stolen tag node 102 may have with an anchor node 104. A tag node 102 was carried in a vehicle 108 that took a right turn at a legal speed in the diametrically opposite corner from where an anchor node 104 is deployed. The minimum contact time was determined to be 4.4 seconds.

The next experiment was conducted to determine the minimum number of transmissions needed to reliably get transmit a message across on a CC2420 radio of a moving tag node 102 to an anchor node 104 in the same intersection. In all attempts, three transmissions were sufficient.

The third experiment was conducted to measure the time required to obtain an acknowledgement from an anchor node 104 in response to a beacon message from a tag node 102. In most cases, 16 ms was sufficient, but in some exceptional circumstances, 31 ms were needed as depicted in FIG. 19.

These measurements were used determine the maximum duty cycle for the tag node 102. Preferably, the tag node 102 should be able to make at least three attempts to obtain a response from an anchor node 104 before the tag node 102 goes out of range. Also, the tag node 102 preferably would stay awake for at least the minimum time needed to obtain a response to its beacon, which is 31 ms. Given a minimum possible contact time of an anchor node 104 and moving tag node 102, the sleep/wake-up times can be obtained.

For a 4 second contact time, a tag node 102 needs to be awake for a total of 50 ms (including the time for its transmission and initialization) and be asleep for the next 950 ms. This provides for a 5% duty cycle. Several hours of driving were conducted with several tag nodes 102 to validate that tag nodes 102 are reliably detected with this duty cycle. If the parameters change for a different scenario, similar elementary computations can be used to find an appropriate duty cycle.

### Working Example #5

### System Evaluation

An embodiment of the invention was evaluated on a real-life deployment of five anchor nodes 104 that make for a loop in an urban road network. The anchor nodes 104 were located approximately 1.9 miles apart making for a total loop distance of 9.5 miles The x value for Section Coverage was 2 miles Eleven tag nodes 100 (organized in groups of 5, 5, and 1) were carried in a car, while the anchor nodes 100 were held static at the designated anchor node locations (up to 30 meters away from the road). The driving in the loop was repeated 10 times making for a total of 95 miles of driving over more than 5 hours continuously. The five hours of driving spanned heavy, moderate, and light traffic.

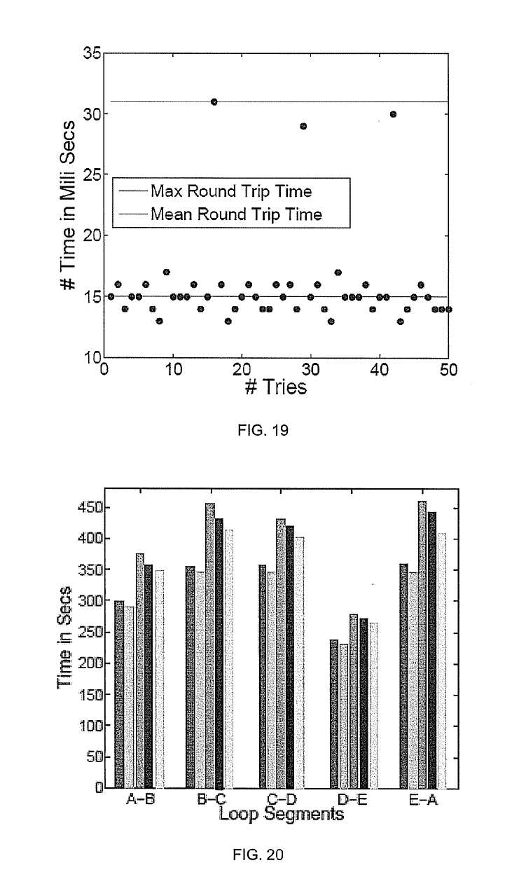

Travel estimates between successive anchor nodes 104 (also called loop segments) were obtained from GOOGLE® Maps (available from Google Inc. of Mountain View, Calif.) and provided by respective anchor nodes 104 in response to the beacons received from tag nodes 102. The results of the experiment appear in FIG. 20. As shown, out of a total of 550 anchor node encounters (11 tag nodes 100, 5 anchor nodes 104, and 10 rounds of the loop), no group ever missed detection by any anchor node 104. The times that tag nodes 102 were able to sleep is represented together with the travel estimate from GOOGLE® Maps, and the actual travel time for each segment of the loop. Out of an average travel time of 32.1 minutes to make one round of the loop, tag nodes 102 spent 26.16 minutes in deep sleep (state 512), representing an enhancement in the trackable lifetime by more than fivefold, as compared to the approach of keeping the tag nodes 102 continuously on a low 5% duty cycle and not sleeping between anchor nodes 104, making recovery and apprehension more likely.

### EQUIVALENTS

The functions of several elements may, in alternative embodiments, be carried out by fewer elements, or a single element. Similarly, in some embodiments, any functional element may perform fewer, or different, operations than those described with respect to the illustrated embodiment. Also, functional elements (e.g., modules, databases, computers, clients, servers and the like) shown as distinct for purposes of illustration may be incorporated within other functional elements, separated in different hardware, or distributed in a particular implementation.

While certain embodiments according to the invention have been described, the invention is not limited to just the described embodiments. Various changes and/or modifications can be made to any of the described embodiments without departing from the spirit or scope of the invention. Also, various combinations of elements, steps, features, and/or aspects of the described embodiments are possible and contemplated even if such combinations are not expressly identified herein.

### INCORPORATION BY REFERENCE

The entire contents of all patents, published patent applications, and other references cited herein are hereby expressly incorporated herein in their entireties by reference.

1. A theft detection system comprising:
one or more tag nodes configured to detect movement and transmit a beacon message; and
one or more anchor nodes configured to:
receive the beacon message from the one or more tag nodes; and
alert a third party of the beacon message.

2. The theft detection system of claim 1, wherein the one or more tag nodes include:
a power source;
a motion detector;
a transmitter;
an accelerometer; and
a microcontroller.

3. The theft detection system of claim 2, wherein the power source is a battery.

4. The theft detection system of claim 2, wherein the motion detector is a vibration dosimeter.

5. The theft detection system of claim 2, wherein the motion detector is a piezoelectric vibratab.

6. The theft detection system of claim 2, wherein the transmitter is a transceiver.

7. The theft detection system of claim 2, wherein the transmitter is IEEE 802.15.4-compliant.

8. The theft detection system of claim 2, wherein the microcontroller is configured to receive a wake-up signal from the motion detector.

9. The theft detection system of claim 1, wherein the one or more anchor nodes include:
a power source;
an infrastructure interface;
an intra-anchor node interface;
a mote; and
a motherboard.

10. The theft detection system of claim 9, wherein the power source includes one or more cells.

11. The theft detection system of claim 9, wherein the infrastructure interface is an IEEE 802.11-compliant transceiver.

12. The theft detection system of claim 9, wherein the intra-anchor node interface is an IEEE 802.15.4-compliant transceiver.

13. The theft detection system of claim 1, wherein the tag node is configured for arming and disarming through a series of accelerations.

14. The theft detection system of claim 1, wherein the tag node is embedded in an electronic device.

15. The theft detection system of claim 1, wherein the tag node is configured to arm and disarm another tag node.

16. The theft detection system of claim 1, wherein the tag node is configured to detect movement in a motor vehicle.

17. The theft detection system of claim 1, wherein the tag node is configured to detect movement in a motor vehicle with a classification algorithm.

18. The theft detection system of claim 1, wherein the one or more anchor nodes are deployed to provide section coverage with diameter x with a region, wherein x is a positive number.

19. The theft detection system of claim 1, wherein the region is one selected from the group consisting of: a precinct, a ward, a municipality, a county, a state, and a country.

20. The theft detection system of claim 1, wherein a subset of the one or more anchor nodes are mounted within law enforcement vehicles.

21. The theft detection system of claim 1, wherein the one or more anchor nodes are configured to transmit an acknowledgment message to a subset of the one or more tag nodes.

22. The theft detection system of claim 1, wherein the acknowledgment message includes an estimated travel time to a nearest anchor node.

23. The theft detection system of claim 1, wherein the acknowledgement message includes instructions to enter a sleep state.

24. The theft detection system of claim 1, wherein the acknowledgement message includes instructions to not enter a sleep state.

25. The theft detection system of claim 1, wherein the acknowledgement message includes one or more group IDs pertaining to one or more subsets of the tag nodes.

26. The theft detection system of claim 1, wherein the third party is a computer.

27. The theft detection system of claim 1, wherein the third party is a law enforcement agency.

28. A theft detection node comprising:
a power source;
a motion detector;
a transmitter; and
a microcontroller in communication with the power source, the motion detector, and the transmitter;
wherein the microcontroller is configured to:
determine whether the node is being transported; and
if the node is being transported, instructing the transmitter to transmit a beacon message.

29. The theft detection node of claim 28, wherein the power source is a battery.

30. The theft detection node of claim 29, wherein the battery is a button cell.

31. The theft detection node of claim 29 wherein the battery is a lithium battery.

32. The theft detection node of claim 28, wherein the motion detector is a vibration dosimeter.

33. The theft detection node of claim 28, wherein the motion detector is a piezoelectric vibratab.

34. The theft detection node of claim 28, wherein the transmitter is a radio transmitter.

35. The theft detection system of claim 28, wherein the transmitter is a transceiver.

36. The theft detection system of claim 28, wherein the transmitter is IEEE 802.15.4-compliant.

37. The theft detection system of claim 28, wherein the microcontroller is configured to receive a wake-up signal from the motion detector.

38. The theft detection node of claim 28, wherein the microcontroller is configured to determine whether the theft detection node is being transported in motor vehicle.

39. The theft detection node of claim 38, wherein the microcontroller determines whether the node is being transported by a motor vehicle with a classification algorithm.

40. A theft detection method comprising:
detecting motion in a motor vehicle; and
transmitting a beacon message to an anchor node.

41. The theft detection method of claim 40, further comprising:
receiving a wake-up signal from a motion detector.

42. The theft detection method of claim 40, further comprising:
receiving an acknowledgement message from the anchor node.

43. The theft detection method of claim 40, further comprising:
entering a sleep mode.

44. The theft detection method of claim 40, further comprising:
transmitting a second beacon message.

45. A theft detection method comprising:
receiving a beacon message from a tag node;
transmitting an acknowledgement message to the tag node; and
alerting a third party of the beacon message.

46. The theft detection method of claim 45, wherein the acknowledgment message includes a travel time to a nearest anchor node.
